(19) United States
(12) Patent Application Publication
(10) Pub. No.: US 2024/0421336 A1
(43) Pub. Date: Dec. 19, 2024

(54) METHOD FOR MANUFACTURING FUEL CELL AND FUEL CELL

(71) Applicant: TOYOTA JIDOSHA KABUSHIKI KAISHA, Toyota-shi (JP)

(72) Inventors: Kaoru Minagawa, Toyota-shi (JP); Yuki Mimura, Okazaki-shi (JP); Kazutaka Tachibana, Nagoya-shi (JP)

(73) Assignee: TOYOTA JIDOSHA KABUSHIKI KAISHA, Toyota-shi (JP)

(21) Appl. No.: 18/668,362

(22) Filed: May 20, 2024

(30) Foreign Application Priority Data
Jun. 16, 2023 (JP) 2023-099048

(51) Int. Cl. H01M 8/2404; H01M 8/0284; H01M 8/0286; H01M 8/241

(52) U.S. Cl. CPC H01M 8/2404; H01M 8/0284; H01M 8/0286; H01M 8/241

(57) ABSTRACT

A method for manufacturing a fuel cell in which the bonding strength between a separator and a sealing member is high, and provides such a fuel cell are provided. A method for manufacturing a fuel cell according to the present disclosure is a method for manufacturing a fuel cell, the fuel cell including: a plurality of stacks each including a membrane electrode assembly and a pair of separators holding the membrane electrode assembly therebetween; and a sealing part provided so as to form a sealed space for a gap formed between stacks adjacent to each other in a stacking direction as the plurality of stacks are stacked at predetermined intervals. The sealing part is formed by melting a resin layer provided between the separator and a sealing member and thereby bonding the separator and the sealing member to each other.

### CROSS REFERENCE TO RELATED APPLICATIONS

This application is based upon and claims the benefit of priority from Japanese patent application No. 2023-099048, filed on Jun. 16, 2023, the disclosure of which is incorporated herein in its entirety by reference.

### BACKGROUND

The present disclosure relates to a method for manufacturing a fuel cell and a fuel cell.

A fuel gas for generating electricity and cooling water for removing heat generated by the generation of electricity are supplied to a fuel cell. Sealing members for preventing such a fuel gas and cooling water from leaking to the outside of the fuel cell have been developed.

For example, Japanese Unexamined Patent Application Publication No. 2016-018703 discloses a sealing member for preventing a fuel gas from leaking to the outside of a fuel cell. In the sealing member disclosed in Japanese Unexamined Patent Application Publication No. 2016-018703, an adhesive layer is stacked and integrated on the surface of the main part of the sealing member made of foamed rubber. The sealing member disclosed in Japanese Unexamined Patent Application Publication No. 2016-018703 is provided on the separator so as to firmly adhere to the separator.

### SUMMARY

In the sealing member disclosed in Japanese Unexamined Patent Application Publication No. 2016-018703, the sealing member is merely adhered to the separator by cross-linking, so that the bonding strength between the separator and the sealing member is insufficient.

The present disclosure has been made in view of the above-described circumstances, and provides a method for manufacturing a fuel cell in which the bonding strength between a separator and a sealing member is high, and provides such a fuel cell.

A method for manufacturing a fuel cell according to the present disclosure is a method for manufacturing a fuel cell,
the fuel cell including:
a plurality of stacks each including a membrane electrode assembly and a pair of separators holding the membrane electrode assembly therebetween; and
a sealing part provided so as to form a sealed space for a gap formed between stacks adjacent to each other in a stacking direction as the plurality of stacks are stacked at predetermined intervals,
the method including forming the sealing part by melting a resin layer provided between the separator and a sealing member and thereby bonding the separator and the sealing member to each other.

In the method for manufacturing a fuel cell according to the present disclosure, the sealing part is formed by bonding the separator and the sealing member to each other by melting and solidifying the resin layer. Therefore, it is possible to manufacture a fuel cell in which the bonding strength between a separator and a sealing member is high.

Further, at least both the sealing member and the resin layer may be heated in a state in which the resin layer is disposed between the separator and the sealing member, so that the resin layer may be melted while the sealing member is being cross-linked, and the separator and the sealing member may be thereby bonded to each other.

By the above-described configuration, the sealing member is heated and cross-linked, so that it is solidified. Further, since the resin layer is heated and melted, and then cooled and solidified, the separator and the sealing member are bonded to each other, and the sealing part is thereby formed. Therefore, it is possible to manufacture a fuel cell in which the bonding strength between a separator and a sealing member is high.

Further, after the sealing member is cross-linked, the resin layer may be disposed at a place where the resin layer is in contact with the sealing member. Then, the separator and the sealing member may be bonded to each other by heating, thereby melting the resin layer.

By the above-described configuration, the cross-linked and solidified sealing member and the resin layer are disposed so that they are in contact with each other. Further, since the resin layer is heated and melted, and then cooled and solidified, the separator and the sealing member are bonded to each other, and the sealing part is thereby formed. Therefore, it is possible to manufacture a fuel cell in which the bonding strength between a separator and a sealing member is high.

The separator, on a surface of which the resin layer has been temporarily bonded, may be disposed in a mold for molding the sealing part, and
the sealing member may be injected into the mold, thereby filling the mold with the sealing member, so that the resin layer may be provided between the separator and the sealing member.

By the above-described configuration, the mold is filled with the sealing member so that the sealing member covers the separator, on the surface of which the resin layer has been temporarily bonded, so that the resin layer can be disposed between the separator and the sealing member.

A fuel cell according to the present disclosure is a fuel cell in which a plurality of stacks each including a membrane electrode assembly and a pair of separators holding the membrane electrode assembly therebetween are stacked at predetermined intervals, in which
a sealing part provided so as to form a sealed space for a gap formed between stacks adjacent to each other in a stacking direction of the stacks includes a resin layer between the separator of the stack and the sealing member.

In the fuel cell according to the present disclosure, the resin layer is provided between the separator of the stack and the sealing member. Therefore, it is possible to reduce the variations in the bonding strength in the interface between the separator and the sealing member, and thereby to provide a fuel cell in which the bonding strength between a separator and a sealing member is high.

According to the present disclosure, it is possible to provide a method for manufacturing a fuel cell in which the bonding strength between a separator and a sealing member is high, and to provide such a fuel cell.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view of a fuel cell according to a first embodiment;

FIG. 2 shows cross-sectional diagrams (xz-plan views) of the fuel cell according to the first embodiment;

FIG. 3 is a cross-sectional diagram (yz-plan view) of the fuel cell according to the first embodiment;

FIG. 4 is a cross-sectional diagram of a sealing part of the fuel cell according to the first embodiment;

FIG. 5 is a schematic view showing an example of a method for manufacturing a fuel cell according to the first embodiment; and

FIG. 6 is a schematic view showing the example of the method for manufacturing a fuel cell according to the first embodiment.

### DESCRIPTION OF EMBODIMENTS

The present disclosure will be described hereinafter through embodiments, but the invention according to the claims is not limited to the below-shown embodiments. Further, all the components/structures described in an embodiment are not necessarily essential as means for solving the problem. For clarifying the explanation, the following descriptions and drawings are partially omitted and simplified as appropriate. The same reference numerals (or symbols) are assigned to the same elements throughout the drawings, and redundant descriptions are omitted as appropriate. Note that, needless to say, right-handed xyz-orthogonal coordinates shown in the drawings are shown just for the sake of convenience for explaining the positional relation among components. In general, the z-axis positive direction is the vertically upward direction and the xy-plane is a horizontal plane.

### First Embodiment

### <Configuration of Fuel Cell>

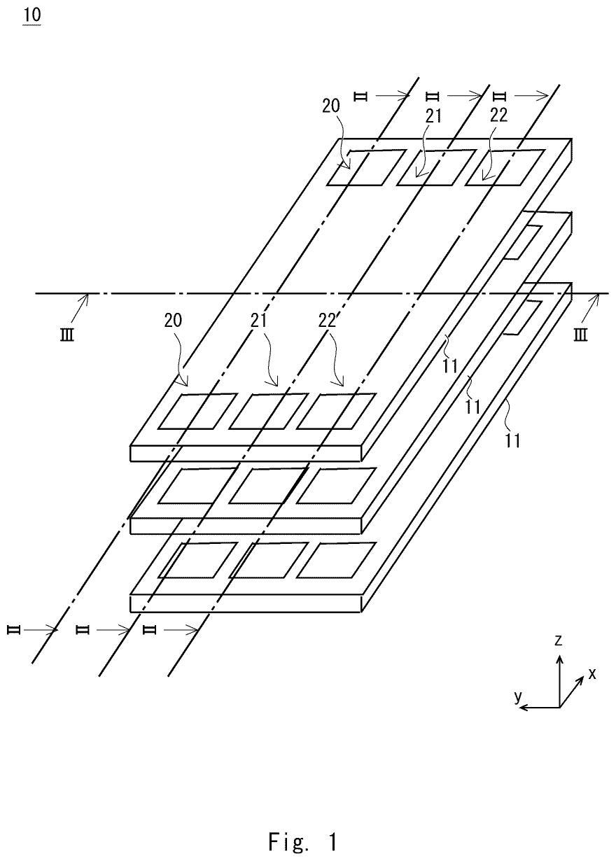

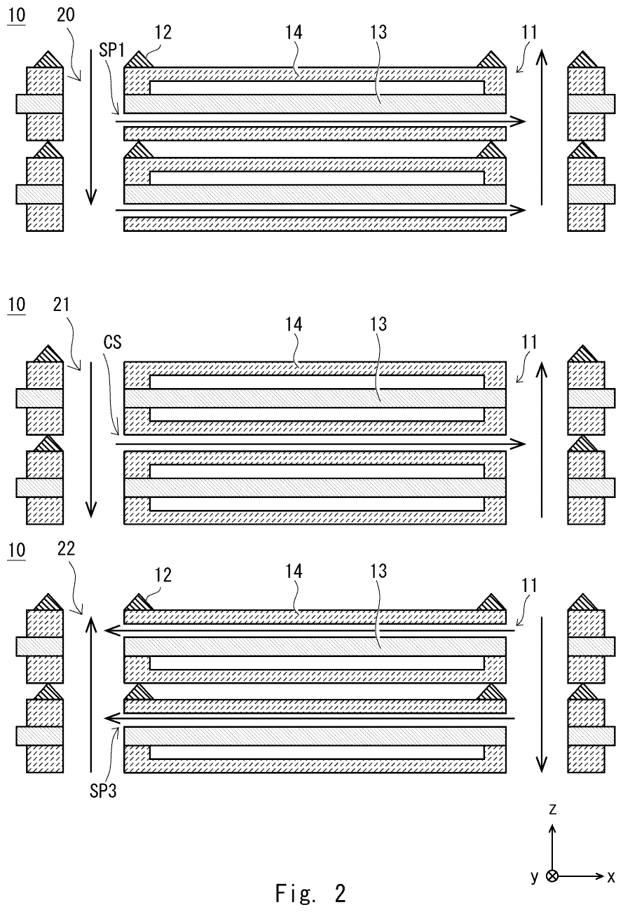

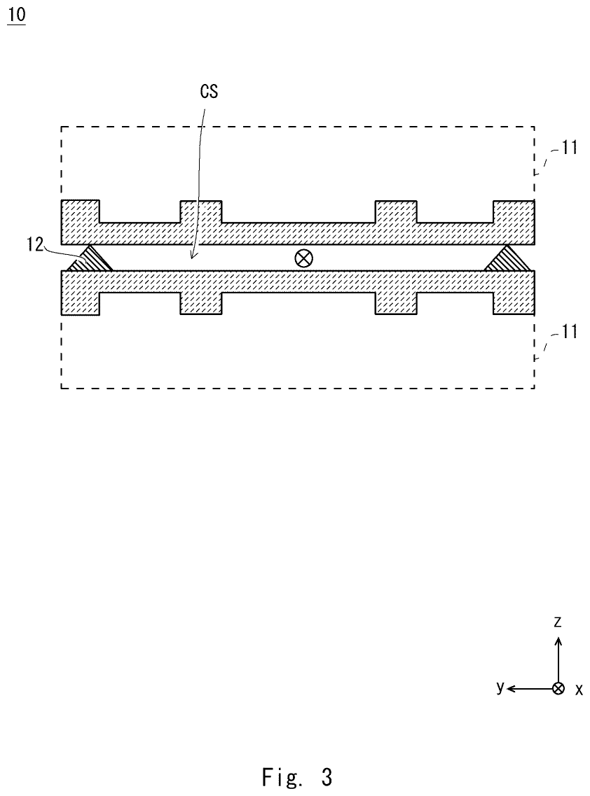

Firstly, a configuration of a fuel cell will be described with reference to FIGS. 1 to 3. FIG. 1 is a perspective view of a fuel cell according to a first embodiment. FIG. 2 shows cross-sectional diagrams (xz-plan views) of the fuel cell according to the first embodiment. FIG. 3 is a cross-sectional diagram (yz-plan view) of the fuel cell according to the first embodiment. In FIGS. 1 to 3, only the parts of the fuel cell related to the generation of electricity are shown, while other members thereof such as a restraining plate are omitted.

The upper part of FIG. 2 shows a cross-sectional diagram taken along a line passing through the manifold holes 20 in FIG. 1. The middle part of FIG. 2 shows a cross-sectional diagram taken along a line passing through the manifold holes 21 in FIG. 1. The lower part of FIG. 2 shows a cross-sectional diagram taken along a line passing through manifold holes 22. In FIG. 3, a cross section between stacks adjacent to each other is shown, and structures other than the separator of the stack are omitted and indicated by dotted lines.

As shown in FIG. 1, a plurality of stacks 11 are stacked at predetermined intervals in the fuel cell 10. In the example shown in FIG. 1, three stacks 11 are stacked in the z-axis direction in the fuel cell 10. In the following description, the z-axis direction in the drawing is referred to as the stacking direction. Note that FIGS. 2 and 3 show a state in which two stacks 11 are stacked.

The stacks 11 will be described with reference to FIGS. 2 and 3. As shown in FIGS. 2 and 3, the stack 11 (i.e., each stack 11) includes a membrane electrode assembly 13 and a pair of separators 14 holding the membrane electrode assembly 13 therebetween. The membrane electrode assembly 13 includes a polymer electrolyte membrane (not shown), and a cathode electrode (not shown) and an anode electrode (not shown) which are disposed on both sides of the polymer electrolyte membrane, i.e., which are disposed so that the polymer electrolyte membrane is interposed therebetween. The separator 14 (i.e., each of the separator 14) is a member formed of a conductive material, for example, a metal, a carbon material, or a conductive resin material.

As shown in the upper part of FIG. 2, a space SP1 is provided between the membrane electrode assembly 13 and one of the separators 14 in the stack 11. Further, as shown in the lower part of FIG. 2, a space SP3 is provided between the membrane electrode assembly 13 and the other separator 14 in the stack 11. Further, as shown in FIG. 3, a gap is formed between stacks 11 adjacent to each other in the stacking direction. Sealing parts 12 are provided in the gap. That is, sealing parts 12 are provided so as to form a sealed space (or a closed space) CS for the gap formed between stacks 11 adjacent to each other in the stacking direction.

Next, flow paths of hydrogen, oxygen, and cooling water supplied to the fuel cell will be described with reference to FIGS. 1 to 3. In FIGS. 2 and 3, the directions of the flows of hydrogen, oxygen and cooling water are indicated by arrows. The arrow in FIG. 3 indicates that cooling water flows from the frond side (x-axis negative side) of the drawing to the back side (x-axis positive side) of the drawing. Hydrogen is supplied so as to flow through one of the manifold holes 20 from the z-axis positive side to the z-axis negative side. Hydrogen passes through the space SP1 from the x-axis negative side to the x-axis positive side. Hydrogen flows through the other manifold hole 20 from the z-axis negative side to the z-axis positive side, and then is collected.

Oxygen is supplied so as to flow through one of the manifold holes 22 from the z-axis negative side to the z-axis positive side. Oxygen passes through the space SP3 from the x-axis positive side to the x-axis negative side. Oxygen flows through the other manifold hole 22 from the z-axis positive side to the z-axis negative side, and then is collected.

Cooling water supplied so as to flow through one of the manifold holes 21 from the z-axis positive side to the z-axis negative side. Cooling water passes through the sealed space CS from the x-axis negative side to the x-axis positive side. Cooling water flows through the other manifold hole 21 from the z-axis negative side to the z-axis positive side, and then is collected. That is, in the fuel cell 10, in order to prevent the cooling water from leaking from the fuel cell 10, the sealed space CS is formed by providing the sealing parts 12, and the cooling water passes through the sealed space CS.

### <Structure of Sealing Part>

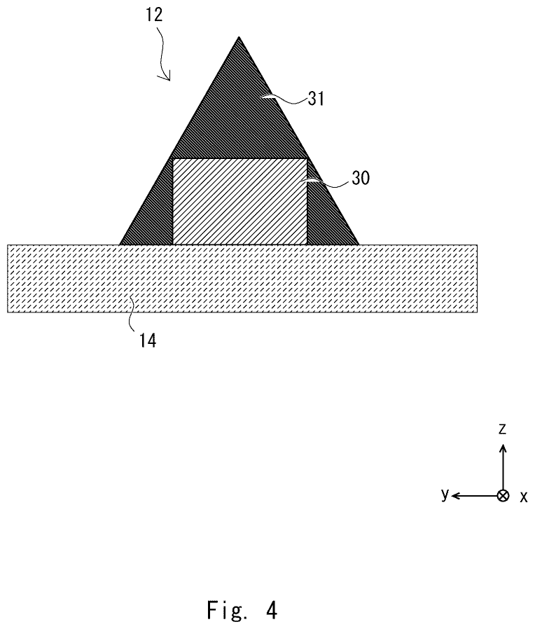

Next, a structure of the sealing part of the fuel cell will be described with reference to FIG. 4. FIG. 4 is a cross-sectional diagram of the sealing part of the fuel cell according to the first embodiment. FIG. 4 shows a yz-plan view of one of the separators 14 and the sealing part 12 of the stack 11, and the other separator 14 and the membrane electrode assembly 13 of the stack 11 are omitted.

As shown in FIG. 4, the sealing part 12 includes a sealing member 31 and a resin layer 30. In the sealing part 12, the resin layer 30 is provided between the separator 14 and the sealing member 31. In the example shown in FIG. 4, the sealing part 12 is formed so that the sealing member 31 covers the front surface and the side surfaces of the resin layer 30 disposed on the separator 14. However, the structure of the sealing part 12 is not limited to the example shown in FIG. 4, and the sealing part 12 may be formed so that the sealing member 31 is stacked on the whole or a part of the surface of the resin layer 30 disposed on the separator 14.

The sealing member 31 is made of a rubber material and, for example, made of ethylene propylene diene rubber. The resin layer 30 is made of a thermoplastic resin, and is in a solid state and has a sheet-like shape. The thermoplastic resin is, for example, polyethylene, which is a crystalline resin, or polyvinyl chloride, which is a non-crystalline resin.

As described above, the resin layer 30 is provided between the separator 14 of the stack and the sealing member 31 in the fuel cell according to the first embodiment. Since the resin layer 30 has a sheet-like shape and firmly adheres to the separator 14, there are few defects such as voids in the interface between the separator 14 and the sealing member 31. As a result, it is possible to reduce the variations in the bonding strength in the interface between the separator 14 and the sealing member 31. Therefore, peeling is prevented from occurring in the interface between the separator 14 and the sealing member 31, so that a fuel cell in which the bonding strength between the separator 14 and the sealing member 31 is high is obtained.

### <Method for Manufacturing Fuel Cell>

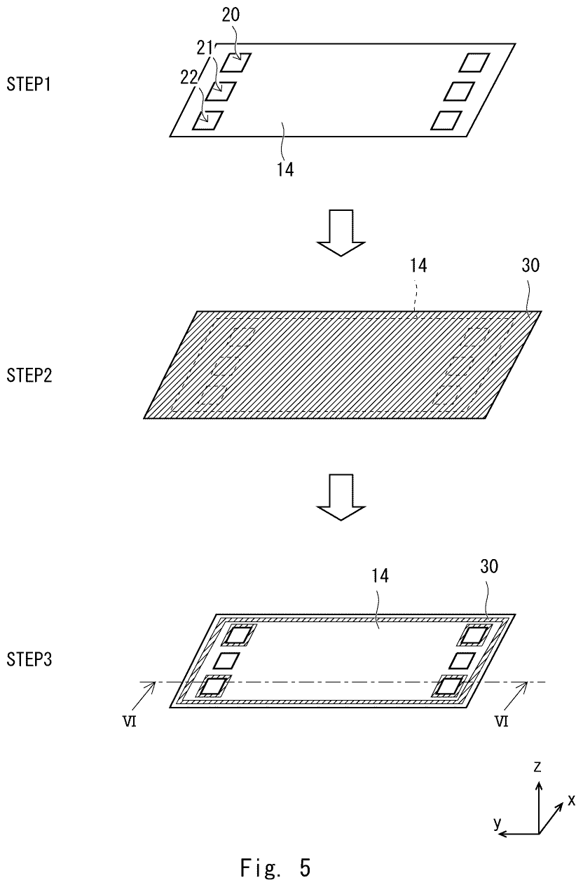

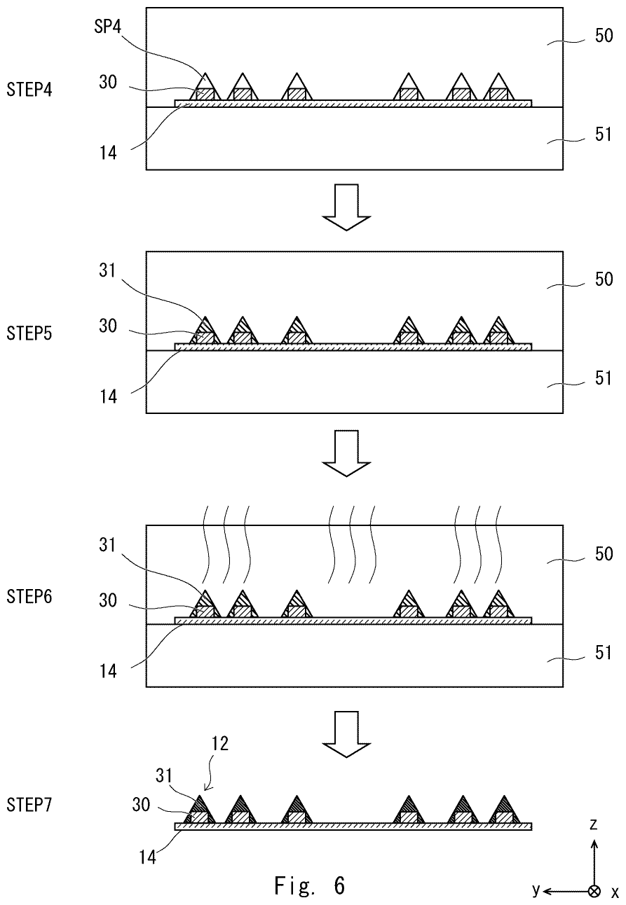

Next, a method for manufacturing a fuel cell will be described with reference to FIGS. 5 and 6. FIGS. 5 and 6 are schematic views showing an example of a method for manufacturing a fuel cell according to the first embodiment. FIG. 5 shows perspective views of a separator and a resin layer during the manufacturing process of the fuel cell. FIG. 6 shows cross-sectional diagrams of the separator, the resin layer, and a sealing member during the manufacturing process of the fuel cell. In FIG. 5, steps ST1 to ST3 in the manufacturing process of the fuel cell are shown. In FIG. 6, steps ST4 to ST7 in the manufacturing process of the fuel cell are shown.

In FIGS. 5 and 6, a method for manufacturing a fuel cell using a method in which a sealing member 31 is injection-molded is shown. Note that in the example of the method for manufacturing the fuel cell shown in FIGS. 5 and 6, the steps ST1 to ST7 are performed one after another.

The steps ST1 to ST3 will be described with reference to FIG. 5. Firstly, a separator 14 is prepared (Step ST1). As shown in FIG. 5, the separator 14 includes manifold holes 20, 21 and 22.

Next, a sheet-like resin layer 30 is disposed on the separator 14 (Step ST2). More specifically, the resin layer 30 is disposed on the surface of the separator 14 and temporarily bonded to the separator 14. This temporary bonding is made to prevent the resin layer 30 from being peeled from the separator 14 due to the injection of the sealing member performed in the step ST5. Further, this temporary bonding is made to prevent the resin layer 30 from being displaced from the separator 14 when the separator 14, on the surface of which the resin layer 30 has been provided, is disposed in the mold in the step ST4. The temporary bonding of the resin layer 30 to the separator 14 is made by, for example, laser irradiation, thermal compression bonding, ultrasonic compression bonding, or vibration compression bonding.

Next, excess parts of the resin layer 30 are removed (Step ST3). More specifically, excess parts of the resin layer 30 are removed so that the resin layer 30 is disposed in the periphery of the separator 14 and in the peripheries of the manifold holes 20 and 22. The excess parts of the resin layer 30 are removed, for example, by laser irradiation or by using a cutting tool.

The steps ST4 to ST7 will be described with reference to FIG. 6. Following the step ST3, the separator 14, on the surface of which the resin layer 30 has been temporarily bonded, is disposed in the mold (Step ST4). The mold includes a pair of movable molds 50 and 51 which can be opened and closed. The movable molds 50 and 51 are opened, and the separator 14, on the surface of which the resin layer 30 has been temporarily bonded, is disposed between the movable molds 50 and 51. After that, the pair of movable molds 50 and 51 are closed. In this way, a space SP4 is formed between the mold and the separator 14, on the surface of which the resin layer 30 has been temporarily bonded. Note that one of the movable molds 50 and 51 may be a fixed mold.

Next, the sealing member 31 is injected into the space SP4 inside the mold, and the space SP4 is thereby filled with the sealing member 31 (Step ST5). As a result, the space SP4 is filled with the sealing member 31 so that the sealing member 31 covers the separator 14, on the surface of which the resin layer 30 has been temporarily bonded. Therefore, the resin layer 30 can be disposed between the separator 14 and the sealing member 31.

Next, at least both the sealing member 31 and the resin layer 30 are heated by heating the inside of the mold (Step ST6). More specifically, the sealing member 31 is heated by heating the inside of the mold. As a result, the sealing member 31 is cross-linked and solidified. Further, the resin layer 30 is heated and melted by heating the inside of the mold. After that, the resin layer 30 is cooled and solidified, so that the separator 14 and the sealing member 31 are bonded to each other, and the sealing part 12 is thereby formed. As described above, in the step ST6, it is possible, by one heating process, to melt the resin layer 30 while cross-linking the sealing member 31, and thereby to bond the separator 14 and the sealing member 31 to each other. Note that any method can be used as the method for cooling the resin layer 30 as long as the resin layer 30 can be cooled. For example, natural cooling, water cooling, or air cooling can be used.

Next, the separator 14 is removed by opening the movable molds 50 and 51 (Step ST7). The removed separator 14 includes the resin layer 30 between the sealing member 31 and the separator 14. In other words, in the step ST7, the separator 14 and the sealing part 12, which has been formed so that the sealing member 31 covers the front surface and the side surfaces of the resin layer 30 disposed on the separator 14, are integrated with each other.

As described above, in the method for manufacturing a fuel cell shown in FIGS. 5 and 6, since the sealing member 31 is charged into the mold so as to cover the separator 14, on the surface of which the resin layer 30 has been temporarily bonded, the resin layer 30 can be disposed between the separator 14 and the sealing member 31. After that, as the sealing member 31 is heated, it is cross-linked and solidified. Further, since the resin layer 30 is heated and melted, and then cooled and solidified, the separator 14 and the sealing member 31 are bonded to each other, and the sealing part 12 is thereby formed. As described above, the method for manufacturing a fuel cell according to the first embodiment makes it possible to manufacture a fuel cell in which the bonding strength between the separator 14 and the sealing member 31 is high.

### Modified Example

Note that FIGS. 5 and 6 show a method for manufacturing a fuel cell using a method for injection-molding a sealing member 31. However, the method for manufacturing a fuel cell according to the first embodiment is not limited to the above-described manufacturing method, and may be a method for manufacturing a fuel cell in which the steps ST4 and ST5 are reversed, and the sealing member 31 is transferred. A method for manufacturing a fuel cell in which the sealing member 31 is transferred will be described in a more concrete manner. In the method for manufacturing a fuel cell in which the sealing member 31 is transferred, steps ST1-ST3, ST6 and ST7 are the same as those shown in FIGS. 5 and 6, and therefore descriptions thereof will be omitted.

In the description of the method for manufacturing a fuel cell in which the sealing member 31 is transferred, steps corresponding to the step ST4 and the step ST5 shown in FIG. 6 will be expressed as a step ST4 (transferring) and a step ST5 (transferring), respectively. Further, the description will be made by referring to FIG. 6 as required.

In the step ST4 (transferring), the sealing member 31 is injected into the space SP4 inside the mold, which is formed by closing the mold, and the space SP4 is thereby filled with the sealing member 31. In the step ST5 (transferring), following the step ST4 (transferring), the mold is opened, and the separator 14, on the surface of which the resin layer 30 has been temporarily bonded, is disposed in the mold. In this way, the resin layer 30 can be disposed between the separator 14 and the sealing member 31. Therefore, in the step ST6, at least both the sealing member 31 and the resin layer 30 can be heated by heating the inside of the mold.

As described above, in the method for manufacturing a fuel cell in which the sealing member 31 is injection-molded and the sealing member 31 is transferred, the sealing part 12 is formed by melting the resin layer 30 while cross-linking the sealing member 31 and thereby bonding the separator 14 and the sealing member 31 to each other. Therefore, the method for manufacturing a fuel cell in which the sealing member 31 is injection-molded and the sealing member 31 is transferred makes it possible to manufacture a fuel cell in which the bonding strength between a separator and a sealing member is high.

Further, the method for manufacturing a fuel cell according to the first embodiment is not limited to the method in which the resin layer 30 is melted while cross-linking the sealing member 31. For example, the resin layer 30 may be melted after the sealing member 31 is cross-linked. That is, the method for manufacturing a fuel cell according to the first embodiment may be a manufacturing method in which the resin layer 30 is bonded to the sealing member 31 of which the cross-linking has already been completed.

A method for manufacturing a fuel cell in which the resin layer 30 is bonded to the sealing member 31 of which the cross-linking has already been completed will be described in a more concrete manner. In the method for manufacturing a fuel cell in which the resin layer 30 is bonded to the sealing member 31 of which the cross-linking has already been completed, steps ST1-ST3 and ST7 are the same as those shown in FIGS. 5 and 6, and therefore descriptions thereof will be omitted.

In the method for manufacturing a fuel cell in which the resin layer 30 is bonded to the sealing member 31 of which the cross-linking has already been completed, steps corresponding to the steps ST4 to ST6 shown in FIG. 6 will be expressed as steps ST4 (bonding) to ST6 (bonding), respectively. Further, the description will be given by referring to FIG. 6 as required.

In the step ST4 (bonding), the sealing member 31 is cross-linked. More specifically, the sealing member 31 is injected into the space SP4 inside the mold shown in FIG. 6, and the space SP4 is thereby filled with the sealing member 31. Then, the sealing member 31 is cross-linked by heating the sealing member 31.

Note that in the step ST4 (bonding), a sealing member 31 of which the cross-linking has already been completed may be disposed in the mold. That is, in the step ST4 (bonding), it is sufficient if the cross-linking of the sealing member 31 is completed before the resin layer 30 is disposed in the step ST5.

In the step ST5 (bonding), the resin layer 30 is disposed at a place where the resin layer 30 is in contact with the sealing member 31 of which the cross-linking has already been completed in the step ST4. More specifically, the mold is opened, and the resin layer 30 is provided between the separator 14 and the sealing member 31 of which the cross-linking has already been completed. As a result, a state equivalent to that in the step ST5 shown in FIG. 6 is obtained. However, this state differs from that in the step ST5 shown in FIG. 6 because the cross-linking of the sealing member 31 has already been completed.

In the step ST6 (bonding), the resin layer 30 is heated and melted, so that the separator 14 and the sealing member 31 are bonded to each other, and the sealing part 12 is thereby formed. More specifically, the resin layer 30 is heated and melted by heating the inside of the mold. After that, the resin layer 30 is cooled and solidified, so that the separator 14 and the sealing member 31 of which the cross-linking has already been completed are bonded to each other, and the sealing part 12 is thereby formed.

As described above, in the method for manufacturing a fuel cell in which the resin layer 30 is bonded to the sealing member 31 of which the cross-linking has already been completed, the cross-linked and solidified sealing member and the resin layer are disposed so as to be in contact with each other. By heating the mold, the resin layer is heated and melted, and then cooled and solidified, so that the sealing part in which the separator and the sealing member are bonded to each other is formed. Therefore, in the method for manufacturing a fuel cell in which the resin layer 30 is bonded to the sealing member 31 of which the cross-linking has already been completed makes it possible to manufacture a fuel cell in which the bonding strength between a separator and a sealing member is high.

### <Bonding Strength>

Next, the bonding strength of the sealing part of the fuel cell according to the first embodiment will be described with reference to Table 1. Table 1 is a table showing results corresponding to respective evaluation items in Examples 1 to 11 in which the configuration of the sealing part of the fuel cell is different from each other.

TABLE 1

| | | | Example | | | | | |
|---|---|---|---|---|---|---|---|---|
| | | | | | 3 | 4 | | 6 |
| | | | | 2 | Difference | Difference | 5 | Difference |
| | | | 1 | Difference | in temporary | in temporary | Difference | in bonding |
| | | | Reference | [symbol] | bonding | bonding | [symbol] | method |
| Configuration | Separator [symbol] | | SUS | SUS | SUS | SUS | Resin | SUS |
| | [symbol] | | Nylon | PP | Nylon | PP | Nylon | Nylon |
| | Temporary | [symbol] | [symbol] | [symbol] | — | — | [symbol] | [symbol] |
| | [symbol] | bonding | | | | | | |
| | of resin | [symbol] | — | — | [symbol] | [symbol] | — | — |
| | layer and | | | | | | | |
| | separator | | | | | | | |
| | [symbol] | | EPDM | EPDM | EPDM | EPDM | EPDM | EPDM |
| | Molding | [symbol] | [symbol] | [symbol] | [symbol] | [symbol] | [symbol] | — |
| | method of | [symbol] | — | — | — | — | — | [symbol] |
| | [symbol] | [symbol] | — | — | — | — | — | — |
| Evaluation | Whether [symbol] | [symbol] | No | No | No | No | No | No |
| [symbol] | Degree of | A: No | A | A | B | B | A | A |
| | peeling of | peeling | | | | | | |
| | temporary | B: Partially | | | | | | |
| | bonding | peeled | | | | | | |
| | [symbol] | [symbol] | | | | | | |
| | | C: Peeled | | | | | | |
| | [symbol] | [symbol] | Cohesive | Cohesive | Cohesive | Cohesive | Cohesive | Cohesive |
| | | | [symbol] | [symbol] | [symbol] | [symbol] | [symbol] | [symbol] |
| | | [symbol] | [symbol] | [symbol] | [symbol] | [symbol] | [symbol] | [symbol] |

| | | | Example | | | | |
|---|---|---|---|---|---|---|---|
| | | | 7 | 8 | 9 | 10 | 11 |
| | | | Difference | Difference | Difference | Difference | Difference |
| | | | in bonding | in heating | in heating | in heating | in heating |
| | | | method | temperature | temperature | temperature | temperature |
| Configuration | Separator [symbol] | | SUS | SUS | SUS | SUS | SUS |
| | [symbol] | | Nylon | Nylon | Nylon | Nylon | Nylon |
| | Temporary | [symbol] | [symbol] | [symbol] | [symbol] | [symbol] | [symbol] |
| | [symbol] | bonding | | | | | |
| | of resin | [symbol] | — | — | — | — | — |
| | layer and | | | | | | |
| | separator | | | | | | |
| | [symbol] | | EPDM | EPDM | EPDM | EPDM | EPDM |
| | Molding | [symbol] | — | [symbol] | — | [symbol] | — |
| | method of | [symbol] | — | — | [symbol] | — | [symbol] |
| | [symbol] | [symbol] | [symbol] | — | — | — | — |
| Evaluation | Whether [symbol] | [symbol] | No | No | No | No | No |
| [symbol] | Degree of | A: No | A | A | A | A | A |
| | peeling of | peeling | | | | | |
| | temporary | B: Partially | | | | | |
| | bonding | peeled | | | | | |
| | [symbol] | [symbol] | | | | | |
| | | C: Peeled | | | | | |
| | [symbol] | [symbol] | Cohesive | Cohesive | Cohesive | Cohesive | Cohesive |
| | | | [symbol] | [symbol] | [symbol] | [symbol] | [symbol] |
| | | [symbol] | [symbol] | [symbol] | [symbol] | [symbol] | [symbol] |

[symbol]

indicates data missing or illegible when filed

As shown in Table 1, as the configuration of the sealing part of the fuel cell, various conditions, such as the material of the separator, the material of the resin layer, the method for temporarily bonding the resin layer and the separator, the material of the sealing member, the method for molding the sealing part, and the heating temperature of the mold, are listed. The separator is a substrate mainly made of stainless steel or a resin. In Table 1, the main material is specified in the column for the material of the separator, in which stainless steel is represented by SUS (Steel Use Stainless). The resin layer is a sheet mainly made of a nylon-based resin or a polypropylene-based resin both of which are thermoplastic resins. In Table 1, the main material is specified in the column for the material of the resin layer, in which the polypropylene-based resin is represented by PP (polypropylene).

The method for temporarily bonding the resin layer and the separator is laser bonding or thermal compression bonding. The sealing member is made of ethylene propylene diene rubber. In Table 1, ethylene propylene diene rubber is represented by EPDM (Ethylene Propylene Diene Methylene Linkage) in the column for the material of the sealing member. As described above, the method for molding the sealing part is one of transfer molding, injection molding, and bonding molding. Further, the heating temperature of the mold is one of 190° C., 170° C. and 160° C.

In Table 1, three evaluation items, i.e., whether the separator was contaminated, the degree of peeling of the temporary bonding between the resin layer and the separator, and the result of the peeling test, are listed, in which the results in Examples 1 to 11 corresponding to these evaluation items are shown. Whether the separator was contaminated was checked by visual inspection. The degree of peeling of the temporary bonding between the resin layer and the separator was evaluated (i.e., categorized) into three levels, i.e., there is no peeling of the temporary bonding (A); a part of the temporarily bonded surface is peeled but the resin layer was not displaced from the separator (B); and the temporary bonding was peeled (C).

In the results of the peeling tests shown in Table 1, the state of a broken part, and the ratio of cohesive broken part of the resin layer in the broken part are shown. The cohesive breakage of a resin layer indicates a state in which cracks are formed inside the resin layer and hence the resin layer is broken. The interface breakage indicates a state in which cracks are formed in the interface between the resin layer and the separator and hence the interface is broken. Therefore, the fact that the ratio of the cohesive breakage of the resin layer in the broken part is high indicates that the ratio of the internal breakage of the resin layer is higher than that of the interface between the sealing member and the separator. That is, the higher the ratio of the cohesive breakage of the resin layer in the broken part is, the higher the bonding strength of the sealing part is, which means the more the result is desirable.

Examples 1, 6 and 7 shown in Table 1 will be described. The methods for molding the sealing part in Examples 1, 6 and 7 differ from one another, but the configurations of them other than the methods for molding the sealing part are the same as each other. No contamination was observed in any of the separator of Examples 1, 6 and 7. Further, the temporary bonding between the separator and the resin layer was not peeled in any of Examples 1, 6 and 7. Further, in all of the Examples 1, 6, and 7, the broken part was in a state in which the resin layer, the cohesive breakage, and the interface breakage were present in a mixed manner.

While the ratio of the cohesive broken part of the resin layer in the broken part was higher than 90% in each of Examples 1 and 6, the ratio of the cohesive broken part of the resin layer in the broken part was 51% to 70% in Example 7. That is, regarding the method for manufacturing a fuel cell according to the first embodiment, the results indicate that the bonding strength between the separator and the sealing member in the manufacturing method in which the method for molding the sealing part was the transfer molding or injection molding was higher than that in the manufacturing method in which the method for molding the sealing part is the bonding molding.

Further, while the materials for the resin layer in Examples 1 and 2 differ from each other, the configurations other than the materials for the resin layer are the same as each other. In each of Examples 1 and 2, the ratio of the cohesive broken part of the resin layer in the broken part is higher than 90%. That is, the method for manufacturing a fuel cell according to the first embodiment makes it possible to manufacture a fuel cell in which the bonding strength between a separator and a sealing member is high irrespective of the material of the resin layer.

Further, while the materials for the separator in Examples 1 and 5 differ from each other, the configurations other than the materials for the separator are the same as each other. In each of Examples 1 and 5, the ratio of the cohesive broken part of the resin layer in the broken part is higher than 90%. That is, the method for manufacturing a fuel cell according to the first embodiment makes it possible to manufacture a fuel cell in which the bonding strength between a separator and a sealing member is high irrespective of the material of the separator.

Note that in the case where the resin is a nylon resin, the melting point of the resin layer is about 170° C. The material of the resin layer is a nylon resin in all of the Examples 1, 8 and 10. When the results of the peeling tests of these examples are sorted according to their satisfactory levels, they are sorted in the order of Examples 1, 8 and 10, of which the heating temperatures of the mold is also in the order of Examples 1, 8 and 10 when being sorted in the descending order. That is, by heating the mold to a temperature equal to higher than the melting point of the resin layer, the ratio of the cohesive broken part of the resin layer in the broken part can be increased, thus making it possible to manufacture a fuel cell in which the bonding strength between a separator and a sealing member is high. Note that in the case where the resin is the polypropylene resin shown in Table 1, the melting point of the resin layer is about 115° C.

As described above, the method for manufacturing a fuel cell according to the first embodiment makes it possible to manufacture a fuel cell in which the bonding strength between a separator and a sealing member is high.

Note that the present disclosure is not limited to the above-described embodiments, and they may be modified as desired within the scope and spirit of the disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A method for manufacturing a fuel cell,
the fuel cell comprising:
a plurality of stacks each comprising a membrane electrode assembly and a pair of separators holding the membrane electrode assembly therebetween; and
a sealing part provided so as to form a sealed space for a gap formed between stacks adjacent to each other in a stacking direction as the plurality of stacks are stacked at predetermined intervals,
the method comprising forming the sealing part by melting a resin layer provided between the separator and a sealing member and thereby bonding the separator and the sealing member to each other.

2. The method for manufacturing a fuel cell according to claim 1, wherein at least both the sealing member and the resin layer are heated in a state in which the resin layer is disposed between the separator and the sealing member, so that the resin layer is melted while the sealing member is being cross-linked, and the separator and the sealing member are thereby bonded to each other.

3. The method for manufacturing a fuel cell according to claim 1, wherein after the sealing member is cross-linked, the resin layer is disposed at a place where the resin layer is in contact with the sealing member; and then the separator and the sealing member are bonded to each other by heating, thereby melting the resin layer.

4. The method for manufacturing a fuel cell according to claim 1, wherein the separator, on a surface of which the resin layer has been temporarily bonded, is disposed in a mold for molding the sealing part, and
the sealing member is injected into the mold, thereby filling the mold with the sealing member, so that the resin layer is provided between the separator and the sealing member.

5. A fuel cell in which a plurality of stacks each comprising a membrane electrode assembly and a pair of separators holding the membrane electrode assembly therebetween are stacked at predetermined intervals, wherein
a sealing part provided so as to form a sealed space for a gap formed between stacks adjacent to each other in a stacking direction of the stacks comprises a resin layer between the separator of the stack and the scaling member.
